(19) United States
(12) Patent Application Publication
(10) Pub. No.: US 2016/0119426 A1
(43) Pub. Date: Apr. 28, 2016

(54) NETWORKED DATA PROCESSING APPARATUS

(71) Applicant: THOMSON LICENSING, Issy-les-Moulineaux (FR)

(72) Inventors: Dirk VAN DE POEL, Aartselaar (BE); Patrick GOEMAERE, Brecht (BE); Kurt JONCKHEER, Antwerpen (BE)

(21) Appl. No.: 14/894,520

(22) PCT Filed: May 26, 2014
(86) PCT No.: PCT/EP2014/060833

§ 371 Date: Nov. 28, 2015

(30) Foreign Application Priority Data
May 30, 2013 (EP) 13305710.9

(51) Int. Cl. H04L 29/08

(52) U.S. Cl. CPC H04L 67/1097; H04L 67/14

(57) ABSTRACT

A networked data processing apparatus includes a first communication interface adapted for transmitting and receiving commands and/or status messages related to a plurality of remotely located network devices connected via the interface, and further includes a first data storage for non-volatile storage of raw data received from the remote network devices. A processing unit of the apparatus is adapted for processing raw data retrieved from the first data storage (104) or received in real-time via the first communication interface. The processing unit further transmits commands and data to the remote network devices in response to processing respective corresponding data. The apparatus further includes a second data storage for non-volatile storage of data processing results and is adapted for maintaining a link between data stored in the second storage and raw data stored in the first data storage. A second communication interface receives and handles data access requests, data processing requests and/or commands, and provides data and/or data processing results in response to the requests.

### FIELD OF THE INVENTION

The present invention relates to a networked data processing apparatus, in particular to a networked data processing system that dynamically connects and provides access to a plurality of network devices located remote from the networked data processing apparatus.

### BACKGROUND OF THE INVENTION

As of today management, control, data transfer and data analysis of a plurality of remote network devices requires a central control unit that is capable of maintaining connections to as many remote network devices as are deployed in a system. In case further remote network devices are to be added for expanding the system, the central control unit must be duplicated, or at least complemented by a suitable further central control unit. These central control units are typically designed to handle a fixed maximum number of remote network devices. If the existing central control unit or units have their respective maximum number of remote network devices attached, adding a single further remote network device to the system will result in a further central control unit having to be added in order to maintain the service at the required service level, e.g. availability, responsiveness, etc. Adding the further central control unit involves continuous fixed costs for maintenance and operation irrespective of the workload, and the investment in the control unit is typically non-negligible. In order to provide for some level of redundancy, one or more central control units may be provided in hot standby, which further increases the costs without initially providing any additional revenue.

It is, therefore, desirable to provide a data processing apparatus that is connected to a plurality of remote network devices for management, control, data transfer and data analysis, which allows for flexible and dynamic adaptation of the system to the number of remote network devices connected thereto, while providing a high availability and service level even under dynamically changing loads.

### SUMMARY OF THE INVENTION

The networked data processing apparatus in accordance with the present invention includes a first communication interface device that is connected to a plurality of remote network devices. The first communication interface device is adapted for transmitting and receiving commands and/or status messages related to the remote network devices.

In an embodiment of the invention the first communication interface device includes a plurality of protocol adaptor devices, each of which is capable of handling a certain number of connections to remote devices using one of a plurality of communication protocols. The protocol adaptor devices send and receive commands and/or status messages from a processing unit device upstream in the structure of the data processing apparatus, which will be discussed further below. The protocol adaptor devices translate or encapsulate messages that are independent from the system hardware into messages in accordance with the respective communication protocol. It is to be noted that the term “message” is interchangeably used for data or commands throughout this specification, unless otherwise noted or obvious from the context. Using protocol adaptors allows for the message content, i.e. the core of the message, to pass through firewalls and survive network address translation, NAT.

In a development of the invention, if multiple connection protocols are to be used at the same time, an according number of protocol adaptor devices are functionally connected with the data processing apparatus.

In yet another embodiment of the invention, the first communication interface is adapted to receive and transmit data and/or commands in an encrypted form.

In an embodiment of the invention, the number and type of protocol adaptor devices that are in functional connection with the data processing apparatus is determined by a broker discovery device. The broker discovery device is the first device of the data processing apparatus in contact with any of the remote network devices and provides load balancing among protocol adaptor devices of the same connection protocol type, including adding further protocol adaptor devices for the same connection protocol, if required, and subsequently performing load balancing. Assignments of remote network devices to protocol adaptor devices are updated accordingly.

Messages received from the remote network devices are stored in a first data storage device providing non-volatile data storage. It is, however, also conceivable to forward the messages directly to the processing unit device, or to do both, i.e. storing and forwarding. Storing and forwarding are controlled by information broker devices, which control the message flow in accordance with a publish and subscribe model, in which a data recipient subscribes to data issued, or published, for that matter, from one or more specific remote network devices.

In case a connection to a remote network device is encrypted, the first data storage device can be adapted to store data in encrypted form. In this case, access is only granted in response to an authorized and/or authenticated request or requester. In this case data operations can also be performed on the encrypted data, depending on the nature of the data and the data processing operations.

Commands to remote network devices can also be distributed in accordance with a publish and subscribe model under control of the information broker devices. In this case a remote network device for example subscribes to specific types of control messages, or to control message from specific issuers, or both. It is, however, also conceivable to send commands directly to specific devices through the information broker devices in an otherwise known manner.

The processing unit device accesses the data from the remote network devices either directly via the information broker devices or through the first data storage device, and performs data processing in accordance with data processing queries, which will be discussed further below. The result of the processing is stored in a second non-volatile data storage device. The processed and un-processed data remain linked across the processing for later reference or further processing. One suitable link, for example, is through the data origin or data type. However, the data may also be linked through other features or tags suitable for maintaining an unambiguous link between raw data and processed data. In addition the link between the data stored in the first data storage device and the data stored in the second data storage device allows for purging all data from both data storage devices in case a remote network device opts out. The link between the two data storage devices may additionally be encrypted for providing a certain degree of privacy, e.g. when the processed data taken alone does not allow for identification of an individual data source.

The data processing apparatus further includes a second communication interface device for accessing the results of the data processing as stored in the second data storage device, or for directly, i.e. through the information broker devices, accessing data provided from the remote network devices. The second communication interface device further allows for accessing the first data storage device, e.g. for performing further processing steps on data stored thereon. In addition, the second communication interface receives and handles data processing requests targeted to the processing unit, and commands to the remote network devices. In this context handling includes returning responses to corresponding individual requests as well as providing data to a general request that is maintained or valid over a period of time or until it is cancelled.

In an embodiment the second communication interface is implemented in the form of an application programming interface, API, through which other devices can access the data and processing in a controllable manner.

In another embodiment the second communication interface is implemented through a web application server providing a user interface adapted to provide access and control to the data, the processing unit and/or the remote network devices. An exemplary embodiment of a user interface is implemented through a web page that visualizes data and may in addition provide selection and control options.

If, depending on the nature of the data and the service provided by the apparatus, or for any other reason, security and/or privacy requirements mandate that access to the data and/or the data processing is restricted, the second communication interface can additionally be adapted to provide authentication and authorization before granting access to the apparatus, irrespective of whether access is granted directly to a user via a user interface or granted to a further data processing system for data extraction and/or transfer.

The inventive data processing apparatus provides decoupling of data sources from data processing, i.e. multiple data processing devices can read data originating from individual remote network devices through accessing the first and/or second data storage devices. The first and second data storage devices are decoupled from the data input interface, allowing for simple data loss prevention at a single point, e.g. through mirroring. The data processing apparatus can easily be scaled for accommodating an increasing number of remote network devices, because adding further protocol adaptor devices, information broker devices and data storage devices can be effected independent from any other device.

Throughout this specification the expression “device” as used in connection with functional elements, unless otherwise noted or obvious from the context, refers to a physically separate unit or to a logical device implemented in software running on a computer or server, either alone or along with other logical devices. For example, the data storage may physically be separated from the processing unit device. Also, the processing unit device may effectively include a plurality of physically separate processing units, e.g. a plurality of computers that are each programmed to execute a specific processing, and that are connected to the data processing apparatus through a network or general data connection.

The expression “real-time” as used throughout the present specification may include situations, in which a delay is present between an event or a message and its progress through the system. Such delay may be unavoidable for technological reasons, e.g. routing, buffering and the like, but still conform to the understanding of “real-time” in computerized control systems. In addition, it will be appreciated that the expression “real-time” as used in this specification may allow for even longer delays as found in computerized control systems. Such relaxed definition of “real-time” will be apparent from the context of an application or system.

In accordance with the invention the various embodiments and developments of elements of the data processing can be implemented individually or in any combination in one data processing apparatus. I.e., specific developments or embodiments pertaining to one element of the data processing apparatus may be present, while other developments and embodiments pertaining to another element of the data processing apparatus may not be implemented in one specific overall apparatus. For example, one implementation of the inventive apparatus may include all embodiments and developments described in the foregoing except for the second communication interface not using APIs. A person skilled in the art will appreciate other combinations of developments and embodiments that fall within the scope and spirit of the present invention.

### BRIEF DESCRIPTION OF THE DRAWINGS

In the following the invention will be described with reference to the drawings, in which

FIG. 1 shows a schematic block diagram of the inventive apparatus;

FIG. 2 shows an exemplary flow of a message through the system; and

FIG. 3 shows an alternative representation of a message flow.

### DETAILED DESCRIPTION OF EXEMPLARY EMBODIMENTS

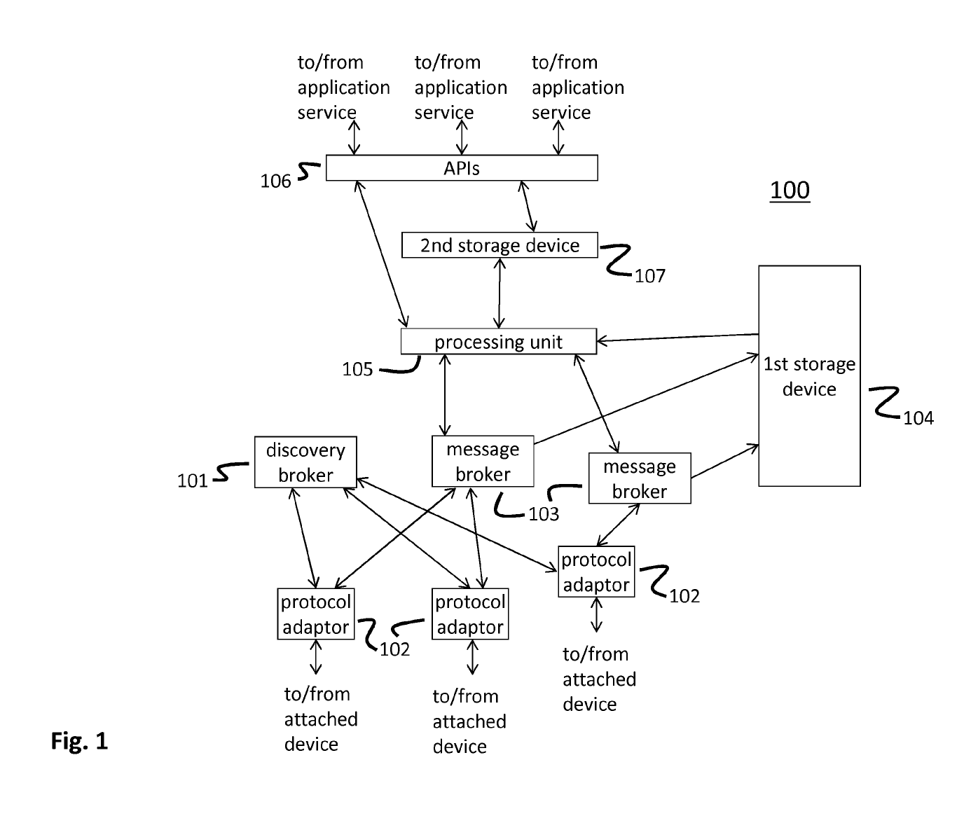

FIG. 1 represents a schematic block diagram of the inventive apparatus, and the interconnection of the key elements. Beginning at the bottom of the figure, network devices, not shown, that are attached to data processing apparatus 100 are connected to discovery broker 101. The connection may be direct, not shown in the figure, or through protocol adaptors 102. Discovery broker 101 assigns respective network attached devices to one of a plurality of message brokers 103 according to a predetermined rule, for example in accordance with a workload of the message brokers 103. Discovery broker may also be involved in routing a network attached device to a protocol adaptor 102 in response to a network attached device requesting attachment to data processing apparatus 100. Protocol adaptors 102 provide bidirectional data transfer between attached devices and message brokers 103. Protocol adaptors 102 and message brokers 103 may simultaneously be connected with a plurality of network attached devices. Data transfer includes transmission and reception of data and commands. The protocol adaptors 102 provide, e.g., access via MQTT protocol, websockets, etc. Data that is received by the message brokers 103 from the attached devices via the protocol adaptors 102, e.g. in accordance with a publish-subscribe operation, is uploaded and stored in a first storage device 104. Processing unit 105 retrieves data from first storage device 104 in accordance with processing operations initiated and/or controlled by service applications, not shown, which will be discussed further below. Alternatively and/or additionally, processing unit 105 is directly connected directly to message brokers 103, which allows for direct access to the attached devices and for real-time processing on data provided directly from the network attached devices. Also, the direct connection allows for direct control of network attached devices. The processing unit may or may effectively not be involved in the real-time processing. The direct connection between processing unit 105 and the service application may be established through one or more application programming interfaces, or APIs, 106. An API may be specific to a service application, and may be specific to general data queries to second storage device 107, to batch operations on data stored in the first or second data storage device 104, 107, or to real-time data and/or command/control operations. The results of the processing by processing unit 105 may be stored in second storage device 107. Processing unit 105 may access data stored in second storage device 107 for further processing thereon. Likewise, application services may access data stored in second storage device 107, e.g. for performing other kinds of data processing.

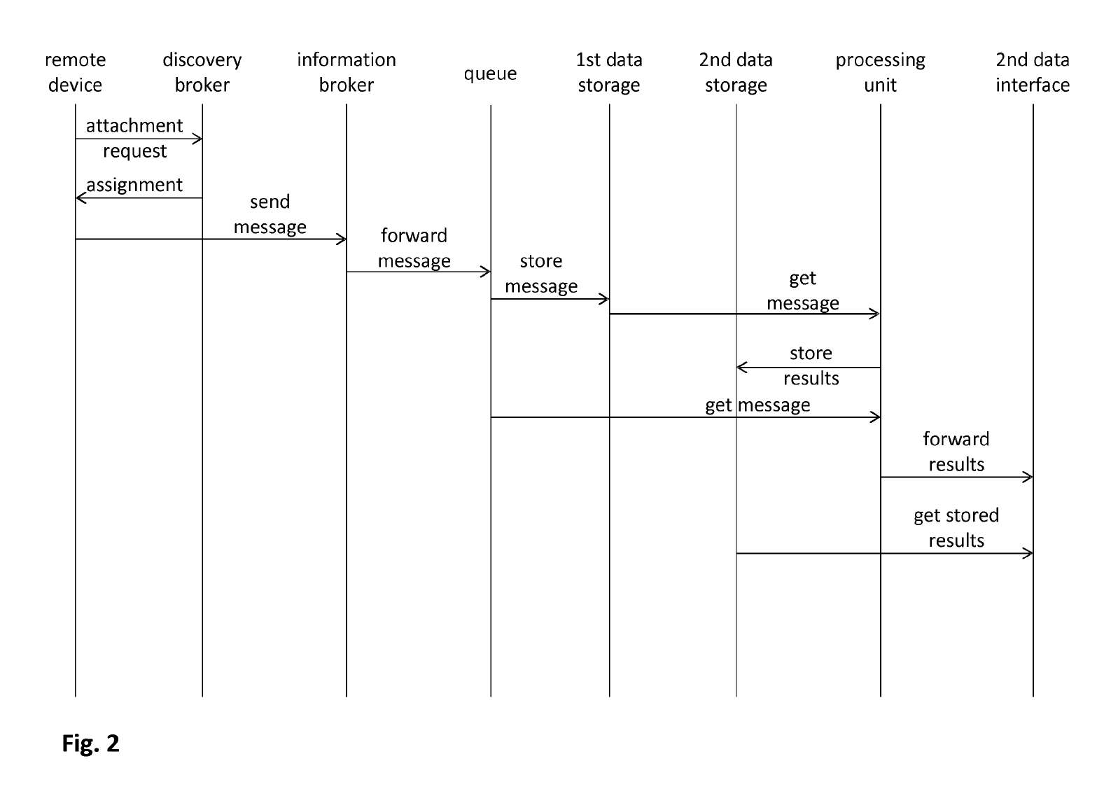

FIG. 2 shows an exemplary message flow through the system. Prior to the actual message exchange a remote device sends an attachment request to a discovery broker, which returns an assignment of the remote device to an information broker. This communication may be done via a secure protocol, e.g. HTTPS or other secure protocols. The discovery broker may assign a remote device to an information broker for example in accordance with load balancing performed amongst multiple information brokers. Then, the remote device sends a message to the information broker, which forwards the published message to any recipient that subscribed to messages originating from a specific remote device. This operation may involve forwarding the message to a queue. The information broker receives the message through a first interface circuit, not shown, which may include a protocol adaptor as discussed with reference to FIG. 1. For example, the message transfer may be triggered in accordance with a publish-and-subscribe operation. An exemplary protocol used is the MQTT protocol, but other protocols can also be used. The queue effectively decouples information brokers and a data processing layer. The queue allows for multiple entities reading data simultaneously.

The queue forwards the message for storage in a first data storage, from where it can be accessed by a processing unit at any time for subsequent processing. The first data storage may for example use a distributed file system that stores all messages from any remote device as they arrive, preferably as raw data, i.e. unprocessed. The distributed file system may for example be implemented as a Hadoop File System, HDFS. However, other file systems can also be used.

Alternatively, the queue allows for the processing unit to directly read the message, e.g. in response to a request issued towards the remote device to provide the message. Direct reading from the queue may be implemented for example through streaming data from the queue as it is available. Streaming may include real-time message processing, analytics, aggregation that are performed in the processing device. An exemplary processing unit for this aspect of the invention is known as Storm Cluster and is used in real-time distributed processing. The processing unit stores the result of the processing in a second data storage, e.g. a NoSQL database, which, in addition to the real-time processing results, also keeps results from previous processing operations. The data stored in the second data storage may also be accessed from application services, not shown, through one or more second interface circuits. Access may be effected through intermediate web application servers, from where the data is provided to application services or their user interfaces or frontends using protocols such as HTTP or JSON. Alternatively or in addition, the processing unit forwards the processing result directly to the second interface circuits for access by the application services, user interfaces, or frontends.

Subsequent processing of data stored in the first data storage may be effected through distributed processing systems, just as described with reference to the real-time processing discussed above. Such processing may include, e.g., map/reduce batch operations on large amounts of data, that are not time-critical. Performing general data aggregation or analytics on older “historic” data is also conceivable and within the scope of the present invention. The results of the subsequent processing are stored in the second data storage and may subsequently be accessed in a similar manner as described further above with reference to the real-time processing.

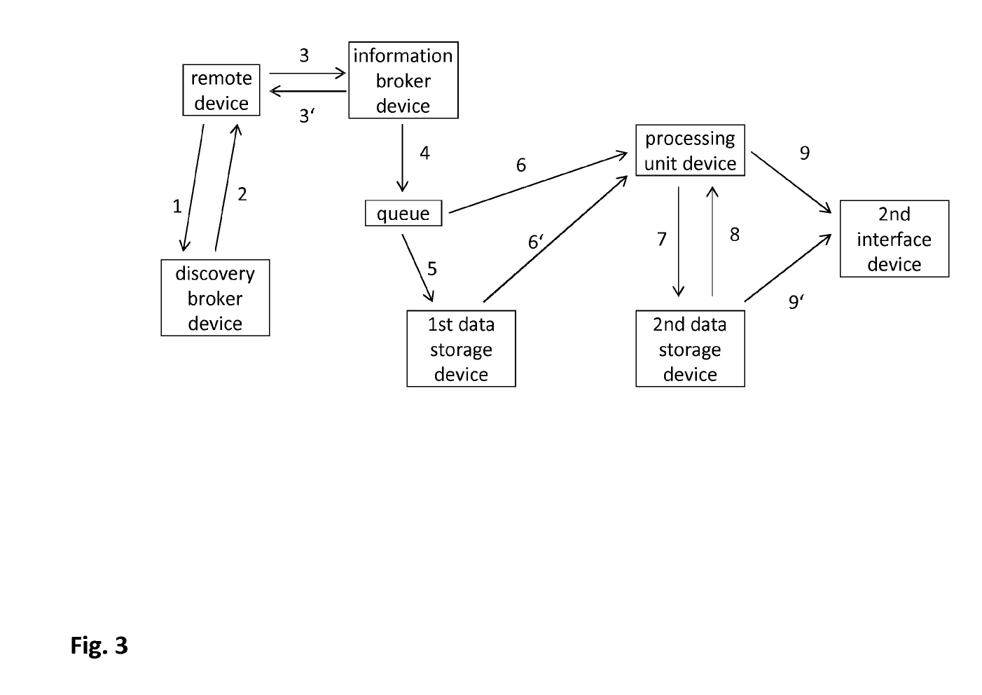

FIG. 3 shows an alternative representation of a message flow and the corresponding flow vectors in accordance with the present invention. First, a remote device sends an attachment request (1) to a discovery broker device, which returns an assignment (2) to an information broker device. Then, the remote device sends (3) a message to the information broker device, which forwards (4) the message to a queue. Commands may be sent (3′) to the remote device through the information broker, as will be discussed further below. The queue either forwards (5) the message to a first storage device, from where it is accessible (6′) by the processing unit device, or forwards (6) it directly to the processing unit device. The processing unit device stores processing results in (7) and/or retrieves processing results from (8) a second storage device. A second data interface receives (9) processing results from the processing device or (9′) from the second data storage. It is to be noted that a command going towards the remote device may take a slightly different path than a data message. For example, a command may be injected to the system at the information broker device. It is, however, also conceivable that the command is routed through the queue and/or through the processing unit device. This case is not represented by flow vectors in the figure, but is easily appreciated by the person skilled in the art.

An exemplary control-type or command-type use of the data processing apparatus pertains to updating remote devices. Such updating process advantageously uses the flexible scaling of the number of remote network devices through the discovery broker and load balancing amongst the first communication interfaces. The updating process may be implemented through a publish-and-subscribe transaction process, in which remote network devices subscribe to an update provider. The network data processing apparatus provides data by multicast or broadcast to the connected remote network devices in accordance with respective subscriptions.

In this example, a plurality of devices subscribes for upgrade command messages, e.g. by providing the information broker of the network data processing apparatus that they are connected to with corresponding information. The network data processing apparatus receives the information, which includes one or more of the type of device, current dataset version or software version, network address, and availability to receive updates. An upgrade command is then received, e.g. via the second communication interface, which is forwarded to all remote network devices via the first communication interfaces and the protocol adapters. The upgrade command can also be issued by a process running in the processing unit of the network data processing apparatus that compares software versions or dataset versions of connected devices of the same type with a latest software version available for each same type of device. In case a newer software version or dataset version is available for a specific type of device, the information broker devices provide the upgrade to the connected devices identified for upgrading. This can be done in an otherwise known manner, e.g. via multicast or broadcast, or via point-to-point transmission. The upgrade is handled as close as possible to the remote network devices, i.e. the upgrade is performed massively parallel simultaneously in the entire system.

The update process can additionally be controlled to be started only if a predetermined minimum number of devices needs to be updated. The update process may however be started despite only fewer devices needing update in case a predetermined time has expired after the subscription for update by one or more of the devices.

1-14. (canceled)

15. A networked data processing apparatus including:
a first communication interface connected to a plurality of network devices located remote from the networked data processing apparatus, wherein the communication interface is adapted for transmitting and receiving commands and/or status messages related to the remote network devices;
a first data storage adapted for non-volatile storage of raw data received from one or more of the plurality of remote network devices;
a processing unit adapted for processing raw data retrieved from the first data storage or received in real-time from the first communication interface, wherein the processing unit is further adapted for transmitting commands and data to one or more of the plurality of remote network devices in response to processing corresponding data related to respective remote network devices, wherein the data processing apparatus includes a second data storage targeted for non-volatile storage of results of the processing performed on the data; the data processing apparatus further being adapted for maintaining a link between the results of the processing stored in the second storage and raw data retrieved from the first data storage; and
a second communication interface adapted for receiving and handling data access requests, data processing requests and/or data processing commands, and for providing data and/or data processing results in response to the requests.

16. The apparatus of claim 15, wherein the first communication interface includes one or more protocol adaptors adapted to provide communication with remote network devices using a plurality of different network communication protocols by extracting message content from received messages and/or encapsulating message content into messages to be transmitted.

17. The apparatus of claim 16, wherein the protocol adaptors are dynamically assigned to remote network devices by a broker device.

18. The apparatus of claim 16, wherein a protocol adaptor is adapted to connect a predefined maximum number of remote network devices, and wherein the broker device assigns a previously not connected remote network device that requests connection to the data processing apparatus to a further, previously not used protocol adaptor in case protocol adaptors actively in use at the time of the request cannot handle further devices.

19. The apparatus of claim 15, wherein components of the data processing apparatus are physically separated from each other and are linked through respective network connections.

20. The apparatus of claim 15, wherein the first communication interface is adapted for authentication of the plurality of remote network devices and/or for message encryption.

21. The apparatus of claim 15, wherein the second communication interface is adapted for receiving processing requests for processing real-time data or data stored in the first data storage, and for queuing and forwarding the processing requests to the data processing unit, or for receiving access requests targeting data stored in the second data storage.

22. The apparatus of claim 15, wherein the second communication interface is connected to an authentication system for selectively providing access to the data processing unit and/or the data storage.

23. The apparatus of claim 15, wherein the second communication interface is adapted for providing a visualization of the data via a web-interface.

24. The apparatus of claim 15, wherein the first data storage stores data items unambiguously linked with a respective remote network device from which the respective data items originate, and wherein the link that is maintained between data items stored in the first data storage and processing results stored in the second data storage is encrypted for maintaining privacy between raw data and processing results.

25. The apparatus of claim 15, wherein the first communication interface, the data processing unit, and/or the second communication interface are instances of software modules running on a cloud-based computer system, and/or wherein the first and/or second data storage are cloud-based non-volatile storage.

26. The apparatus of claim 25, further including a system management unit adapted for determining a computational load on one or more of the instances of software modules, and for adding further instances for a same processing or interfacing task when the computational load of an instance exceeds a predetermined value, or for canceling an instance when the sum of the loads for a same task is lower than the total computational capacity of all instances processing the same task minus one.

27. The apparatus of claim 26, wherein adding further instances includes running an added instance on an additional, separate computer hardware.

28. The system of claim 25, further including a system management unit adapted for relocating software modules and/or data storage between cloud-based computer systems in dependence of the local origin of the data, legal restrictions and provisions, cost and/or performance.
